(19) United States
(12) Patent Application Publication
(10) Pub. No.: US 2026/0037434 A1
(43) Pub. Date: Feb. 5, 2026

(54) FLASH MEMORY CONTROLLER AND COMPENSATION METHOD FOR DYNAMICALLY ADJUSTING OFFSET VALUES OF READ REFERENCE VOLTAGES IN RESPONSE TO DIFFERENT CONDITIONS

(71) Applicant: Silicon Motion, Inc, Hsinchu County (TW)

(72) Inventors: Jian-Dong Du, Taoyuan City (TW); Wei-Min Lai, Hsinchu County (TW)

(73) Assignee: Silicon Motion, Inc, Hsinchu County (TW)

(21) Appl. No.: 19/248,419

(22) Filed: Jun. 24, 2025

Related U.S. Application Data
(60) Provisional application No. 63/676,912, filed on Jul. 30, 2024.

(51) Int. Cl. G06F 12/02

(52) U.S. Cl. CPC G06F 12/0246; G06F 2212/7206

(57) ABSTRACT

A compensation method of a flash memory controller includes: providing a first input/output interface, to be coupled between a host device and an internal bus; providing a second input/output interface, to be coupled between a flash memory device and the internal bus; providing a central processing unit to manage flash memory operations; and, generating an offset value of a specific read reference voltage to compensate a default value of the specific read reference voltage as an actual optimal value based on at least one characteristic model in response to at least one of a data retention time of the flash memory device and a cell count when the default value of the specific read reference voltage is applied.

### CROSS REFERENCE TO RELATED APPLICATIONS

This application claims the benefit of U.S. Provisional Application No. 63/676,912, filed on Jul. 30, 2024. The content of the application is incorporated herein by reference.

### BACKGROUND OF THE INVENTION

### 1. Field of the Invention

The invention relates to a flash memory mechanism, and more particularly to a flash memory controller and a corresponding method of the flash memory controller.

### 2. Description of the Prior Art

Generally speaking, for enterprise applications of flash memory devices, the quality deviation (e.g. deviations of read reference voltages) between NAND packages, blocks and layers becomes larger, and it is also needed to make more efforts to improve the data reliability issue. Also, it will be much more difficult to achieve ideal performance and quality of service for the enterprise applications.

### SUMMARY OF THE INVENTION

Therefore one of the objectives of the invention is to provide a flash memory controller and a corresponding compensation method, to solve the above-mentioned problems.

According to embodiments of the invention, a flash memory controller is disclosed. The flash memory controller comprises an internal bus, a first input/output interface, a second input/output interface, a central processing unit, and an accelerator circuit. The first input/output interface is to be coupled between a host device and the internal bus. The second input/output interface is to be coupled between a flash memory device and the internal bus. The central processing unit is coupled to the internal bus and used for managing flash memory operations. The accelerator circuit is coupled to the internal bus and arranged for generating an offset value of a specific read reference voltage to compensate a default value of the specific read reference voltage as an actual optimal value based on at least one characteristic model in response to at least one of a data retention time of the flash memory device and a cell count when the default value of the specific read reference voltage is applied.

According to the embodiments, a compensation method of a flash memory controller is disclosed. The compensation method comprises: providing a first input/output interface, to be coupled between a host device and an internal bus; providing a second input/output interface, to be coupled between a flash memory device and the internal bus; providing a central processing unit to manage flash memory operations; and, generating an offset value of a specific read reference voltage to compensate a default value of the specific read reference voltage as an actual optimal value based on at least one characteristic model in response to at least one of a data retention time of the flash memory device and a cell count when the default value of the specific read reference voltage is applied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flash memory controller according to an embodiment of the invention.

FIG. 2 is a diagram of a flowchart of optimizing read reference voltage(s) according to an embodiment of the invention.

FIG. 3 is a diagram of an example of performing the big data model training to automatically generate one or more read reference voltage models according to an embodiment of the invention.

FIG. 4 is a diagram of an example of a first linear model, generated by the flash memory controller, which takes the cell count as its input and generates a corresponding offset value of a read reference voltage as its output to generate the actual optimal value of the read reference voltage according to an embodiment of the invention.

FIG. 5 is a diagram of an example of a second linear model, generated by the flash memory controller, which takes the data retention time as its input and generates a corresponding offset value of a read reference voltage as its output to generate the actual optimal value of the read reference voltage according to an embodiment of the invention.

### DETAILED DESCRIPTION

The invention aims at providing a flash memory controller and a compensation method capable of dynamically adjusting offset values of read reference voltages in response to different conditions of one or more flash memory devices such as chips/dies.

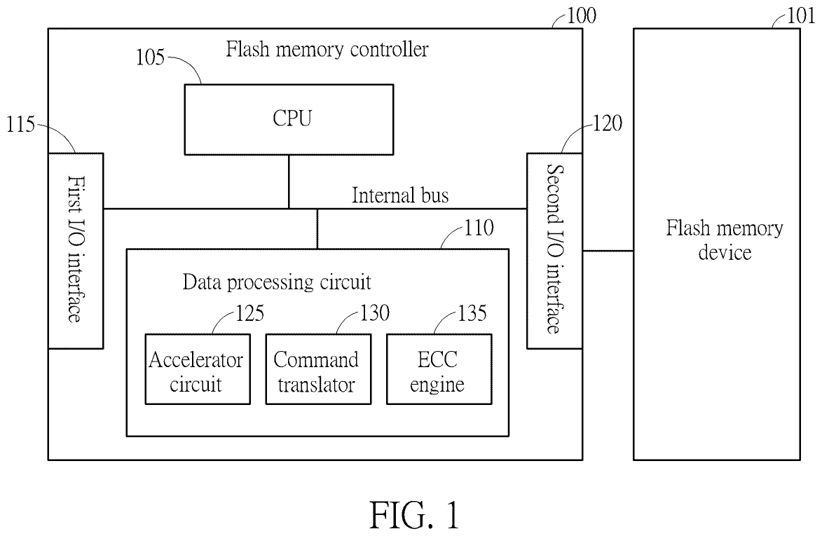

FIG. 1 is a diagram of a flash memory controller 100 according to an embodiment of the invention. The flash memory controller 100 is coupled between a host device (not shown in FIG. 1) and a storage device such as a NAND-type flash memory device 101 such as one or more NAND-type flash memory chips. The flash memory controller 100 comprises a specialized processor (e.g. central processing unit (CPU) 105) designed to manage flash memory operations, a data processing circuit 110, a first input/output (I/O) interface 115, and a second I/O interface 120.

The data processing circuit 110 comprises an accelerator circuit 125, a command translator 130, and an error correction code (ECC) engine 135. That is, the flash memory controller 100 comprises the accelerator circuit 125. The CPU 105, accelerator circuit 125, command translator 130, and ECC engine 135 are coupled to an internal bus of flash memory controller 100. The flash memory controller 100 is coupled to the host device through the first I/O interface 115 and is coupled to the flash memory device 101 through the second I/O interface 120.

The CPU 105 of flash memory controller 100 is arranged to execute firmware(s) that controls the complex operations of reading, writing, and erasing data for the NAND-type flash memory device 101. The operations may comprise translating logical addresses (used by the host device) into physical addresses (used by the flash memory device 101), managing the timings and sequences of flash memory operations, executing wear-leveling algorithms to distribute write operations evenly across the flash memory device 101, controlling the ECC engine 135 to execute ECC operations, controlling the accelerator circuit 125 to execute acceleration operations, and managing the signal interface between the flash memory device 101 and the host device such as a computer device or other devices.

The command translator 130 is used for receiving commands from the host device to interpret the received commands, decoding the commands to obtain the requested operation (read, write, erase) and the associated address(es), performing logical-to-physical address translation to convert logical addresses (used by the host device) into physical addresses (for the flash memory device 101).

The ECC engine 135 is used for performing ECC encoding operation to add redundant information (ECC codes) to the data when the data is to be written to the flash memory device 101, performing the ECC decoding operation to use the redundant information to detect and correct any errors that may have occurred in the data which has been read from the flash memory device 101. The ECC engine 135 may employ for example LDPC (Low-Density Parity-Check) codes.

The accelerator circuit 125 is used for perform hardware acceleration and software acceleration. The accelerator circuit 125 for example is used to optimize the specific tasks such as ECC calculations of the ECC engine 135 and signal filtering and analysis. In addition, the accelerator circuit 125 may be used to optimize the memory access, reduce latency and increase throughput. The accelerator circuit 125 may optimize the algorithms for speed and efficient to reduce the number of the calculations, use caching and pre-fetching techniques to store the frequently accessed data in the flash memory device 101, optimize and manage the mapping between logical and physical addresses to reduce latency and improve performance, and optimize the read retry performance when read errors occur so as increase the chance of a successful data read and to reduce the amount of time that the read retry process takes.

In MLC (multi-level cell), TLC (triple-level cell), and QLC (quad-level cell) flash memory chips, a memory cell is used to store multiple bits using different threshold voltage levels. Each possible data value (e.g. ‘00’, ‘01’, ‘10’, ‘11’) maps to a threshold voltage range. The actual voltage of a memory cell is not fixed and falls within a distribution due to the process variations, program noises, temperature variations, and wear conditions. When it is needed to read a memory cell from MLC, TLC, and QLC flash memory chips, the flash memory controller 100 uses and compares one or more read reference voltages with the memory cell's actual voltage.

Ideally, a default value of a read reference voltage is configured to sit between the state distributions and can be used to determine the logical state of the memory cell. Actually, the data retention loss over time may cause the threshold voltage distributions to shift to the left (downward) due to the charge losses, and this leads to more read errors and state overlap. In this embodiment, the accelerator circuit 125, coupled to the internal bus, is arranged for generating an offset value of a specific read reference voltage to compensate a default value of the specific read reference voltage as an actual optimal value based on at least one characteristic model in response to at least one of a data retention time of the flash memory device and a cell count which falls within a specific range when the default value of the specific read reference voltage is applied. The flash memory controller 100 (or accelerator circuit 125) for example is used to optimize read reference voltage (s) by predicting the offset value (s) between the default value(s) and the actual/optimal read reference voltage(s), so as to reduce the read data errors and improve the efficiency of data reading.

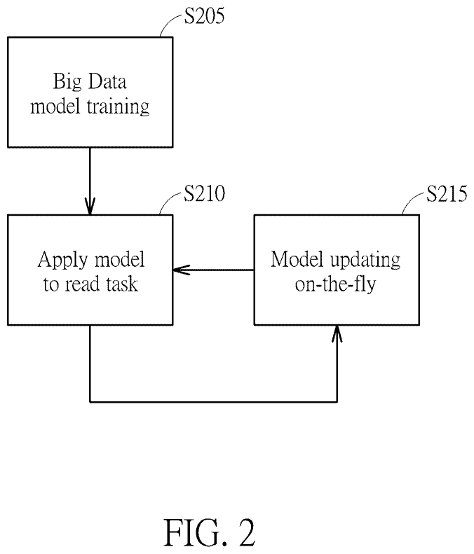

FIG. 2 is a diagram of a flowchart of optimizing read reference voltage (s) according to an embodiment of the invention. As shown in FIG. 2, in Step S205, for example, before the flash memory device 101 leaves the factory, an external computer device such as an external host device may control the flash memory controller 100 to test and scan the flash memory device 101 which may have more flash memory chips, so as to measure and collect data of memory cells, e.g. cell distributions of the data blocks of the flash memory device 101.

For example, the external host device controls the flash memory controller 100 to perform a big data model training to automatically generate one or more read reference voltage models (e.g. a linear model using a linear equation or a non-linear model using a non-linear equation) by training/quantifying characteristic of the measured data for different scenarios. In Step S210, after the flash memory device 101 leaves the factory, the flash memory controller 100 (or accelerator circuit 125) may classify the different read tasks into different groups corresponding to different read reference voltage models respectively, and may select a suitable read reference voltage model for a specific read task to be processed by the flash memory controller 100. That is, the flash memory controller 100 (or accelerator circuit 125) is used to apply a suitable read reference voltage model for a specific read task. In Step S215, the flash memory controller 100 (or accelerator circuit 125) may update the parameters of the read reference voltage models based on scheduled maintenances or retry flows so as to perform the on-the-fly updating for the parameters.

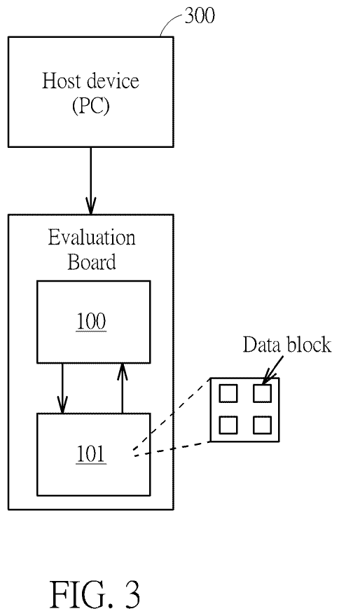

FIG. 3 is a diagram of an example of performing the big data model training to automatically generate one or more read reference voltage models according to an embodiment of the invention. As shown in FIG. 3, an external host device 300 such as a personal computer device, coupled to the evaluation board (EVB), may be used to control the flash memory controller 100 to perform the big data model training to automatically generate one or more read reference voltage models by training/quantifying characteristic of the measured data for different scenarios (i.e. different conditions of the data blocks comprised by the flash memory device 101).

For example, the external host device 300 controls the flash memory controller 100 to measure and collect data of memory cells, e.g. cell distributions of the data blocks of the flash memory device 101. Then, the external host device 300 (or the flash memory controller 100) can train a read reference voltage model which takes the page address, page type, P/E count, cell count, or data retention time as its input and generates a corresponding value of a read reference voltage as its output. The external host device 300 may control the flash memory controller 100 to test the accuracy of the generated and trained read reference voltage model by using such model to read another storage drive (i.e. another different flash memory chip). The accuracy can be measured by the external host device 300 in terms of error bits numbers or differences of read reference voltages. In addition, the flash memory controller 100 may update the generated and trained read reference voltage model when performing read retry operations.

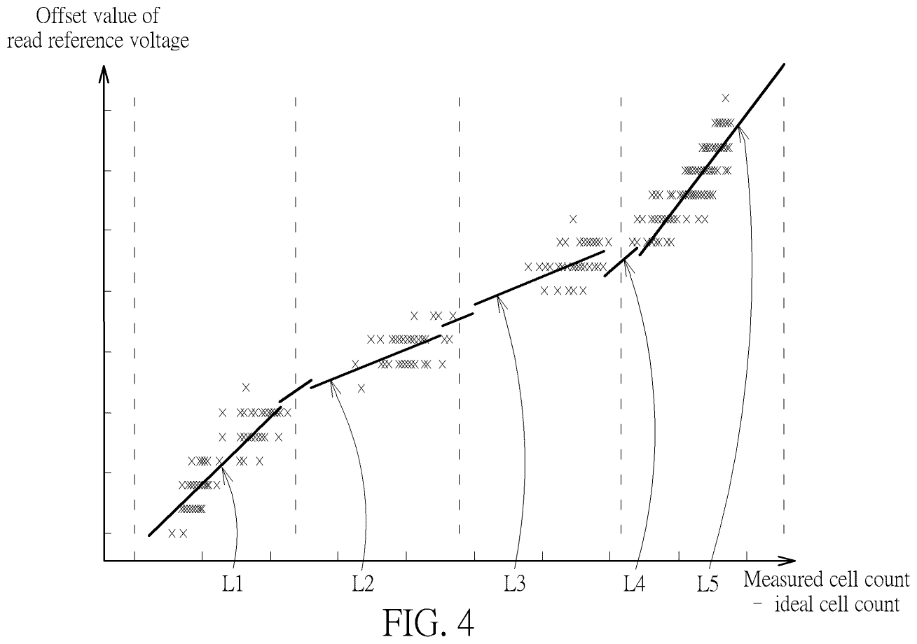

For example, the generated and trained read reference voltage model may be a linear model to predict the offset value(s) between the actual value(s) of the read reference voltage(s) and default value(s) of the read reference voltage(s). In one embodiment, to reduce the calculation amounts, the flash memory controller 100 may use linear model (s) to predict the offset value (s) between the actual value(s) of the read reference voltage(s) and default value(s) of the read reference voltage(s) for the data reading operation since the threshold voltage(s) (i.e. the voltage distribution(s)) of cell (s) in the flash memory device 101 may be shifted and varied over time due to the factors such as program/erase P/E) cycles, data retention, temperature variations, and/or cell-to-cell interference. FIG. 4 is a diagram of an example of a first linear model, generated by the flash memory controller 100, which takes the cell count as its input and generates a corresponding offset value of a read reference voltage as its output to generate the actual optimal value of the read reference voltage according to an embodiment of the invention. In FIG. 4, the values at the horizontal axis indicate the values of the measured cell count minus the ideal cell count, and the values at the vertical axis indicate the offset values of the read reference voltage. The first linear model takes the cell count, e.g. the measured cell count minus the ideal cell count, as its input and correspondingly generates an offset value. The lines L1, L2, L3, L4, and L5 respectively indicate the different characteristics of the first linear model, and their slopes can be different or identical for the different measured cell counts.

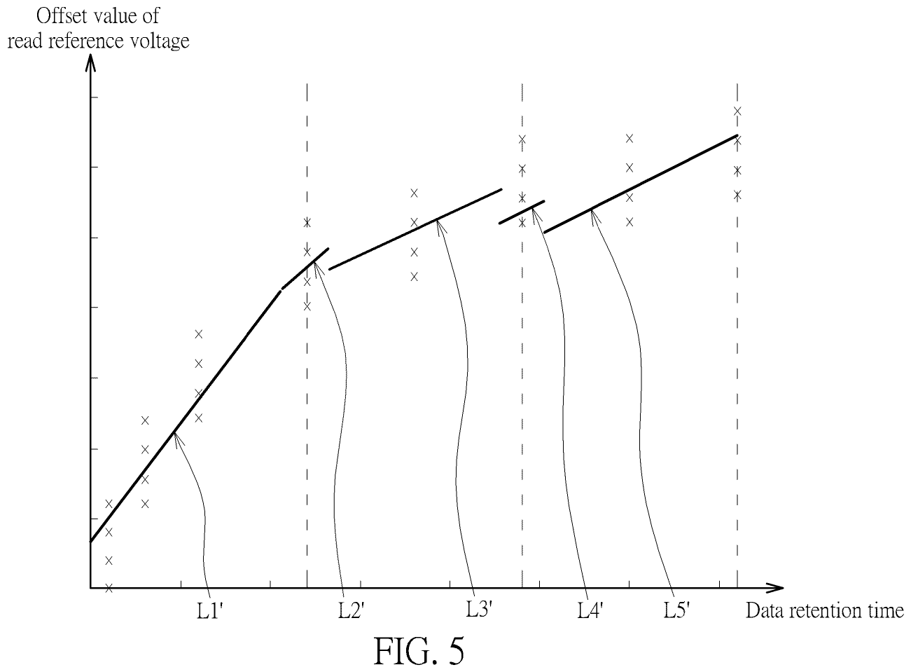

FIG. 5 is a diagram of an example of a second linear model, generated by the flash memory controller 100, which takes the data retention time as its input and generates a corresponding offset value of a read reference voltage as its output to generate the actual optimal value of the read reference voltage according to an embodiment of the invention. In FIG. 5, the values at the horizontal axis indicate the values of the data retention time, and the values at the vertical axis indicate the offset values of the read reference voltage. The lines L1′, L2′, L3′, L4′, and L5′ respectively indicate the different characteristics of the second linear model, and their slopes can be different or identical for the different data retention time.

In practice, for example, the build first linear model may execute based on a first linear equation:

$$y = a \times x + b ;$$

wherein y is the data output of the first linear equation and indicates the estimated/predicted offset value (i.e. a target offset value) of a specific read reference voltage to be moved from the default value into the actual optimal value when it is applied to read data, x is the data input of first linear equation and indicates the number of measured cells (i.e. the value of measured cell count) which fall within a range when data is read with the default value of the specific read reference voltage, and (a,b) are a pair of coefficients/parameters employed by the first linear equation.

When the values of coefficients (a,b) are calculated/updated, the flash memory controller 100 (accelerator circuit 125) can use the first linear equation of first linear model to predict the offset value (i.e. the target offset value) of the specific read reference voltage so as to obtain the actual optimal value of the specific read reference voltage in response to a measured cell count. The values of coefficients (a,b) can be calculated and configured by the external host device 300 such as a computer device in FIG. 3 before the flash memory device 101 leaves the factory or can be online (on-the-fly) updated by the CPU 105 (or accelerator circuit 125) of the flash memory controller 100 after leaving the factory.

In practice, at the beginning, to obtain the initial values of coefficients (a,b) of the first linear equation, the external host device 300 may control the flash memory controller 100 to train the first linear model by collecting corresponding data of voltage values of a specific read reference voltage to read the data of the flash memory device and actually measuring the cell count distribution across threshold voltages. After obtaining multiple sets of different read voltages with different measured cell counts of the cell count distribution, the external computer device 300 can control the flash memory controller 100 to determine a voltage level corresponding to the valley of the cell count distribution as an offset value for the specific read reference voltage. The external computer device 300 can perform the above-mentioned flow for different read reference voltages so as to obtain the relation between the offset values of the different read reference voltages and corresponding cell counts, and then it can use the relation to calculate the coefficients (a,b) by substituting the offset values and corresponding cell counts into the first linear equation y=a×x+b to solve and approximate the coefficients (a,b).

To update the coefficients (a,b) of the first linear equation on-the-fly, the flash memory controller 100 can control the accelerator circuit 125 to perform adaptive read reference tuning based on a specific algorithm such as a recursive least square (RLS) algorithm (but not limited) to real-timely update the values of coefficients (a,b). The specific algorithm in other embodiments can be a machine learning algorithm. For example, based on the RLS algorithm, when obtaining a new data input such as the n-th data input (e.g. the n-th measured cell count xₙ) and the corresponding n-th measured offset value yₙ for the specific read reference voltage, the flash memory controller 100 (or accelerator circuit 125) is arranged to generate a predicted/estimated n-th offset value yₙ′ based on the n-th cell count xₙ and the old/previous values of coefficients (a,b). The flash memory controller 100 calculates the n-th error value eₙ between the predicted/estimated offset value yₙ′ and the measured offset value yₙ. The flash memory controller 100 updates the n-th adaptive gain gₙ by generating the projection of the n-th error value eₙ onto the observation space and normalizing the generated projection. The flash memory controller 100 then calculates and update the n-th estimation uncertainty level [symbol] ₙ by adding the n-th cell count xₙ multiplied by the n-th adaptive gain gₙ into the old/previous estimation uncertainty level (e.g. the (n−1)-th estimation uncertainty level [symbol] ₙ₋₁) so as to indicate whether a system change occurs or not. The flash memory controller 100 finally uses the old/previous values of coefficients (a,b), the n-th error value eₙ, and the n-th adaptive gain gₙ to compute and update the new/next values of coefficients (a,b).

For example, the above-mentioned can be represented by the matrix form (i.e. matrix notation). During the initialization of the coefficient update procedure, the flash memory controller 100 obtains and acquires

$${[ \begin{matrix}a \\ b\end{matrix} ]}_{N - 1}^{*} ,$$

[symbol]

_{N-1}, and λ, wherein

$${[ \begin{matrix}a \\ b\end{matrix} ]}_{N - 1}^{*}$$

is the matrix form/notation of the (N−1)-th values of coefficients (a,b) for the (N−1)-th calculation and updating, [symbol] _{N-1} is the (N−1)-th estimation uncertainty level, and λ is a forgetting factor which may indicate whether the coefficient updating gives more weights to a new observation value or to an old observation value.

Then, for the subsequent calculations and updating at the n-th timing (e.g. n=N,N+1,N+2, . . . ), the flash memory controller 100 obtains the n-th measured cell count xₙ and the measured n-th offset value yₙ, and generates the matrix

$${𝕩}_{n} = [ \begin{matrix}{x}_{n} \\ 1\end{matrix} ]$$

based on the n-th measured cell count xₙ.

Then, the flash memory controller 100 computes the n-th error value

$${e}_{n} = {y}_{n} - {{𝕩}_{n}^{T} [ \begin{matrix}a \\ b\end{matrix} ]}_{n - 1}^{*} ,$$

i.e. computing the n-th error value eₙ between the n-th predicted/estimated offset value

$${{𝕩}_{n}^{T} [ \begin{matrix}a \\ b\end{matrix} ]}_{n - 1}^{*}$$

and the n-th measured offset value yₙ.

Then, the flash memory controller 100 computes the n-th gain

$${g}_{n} = \frac{{λ}^{- 1} {n - 1}_{} {𝕩}_{n}}{1 + {𝕩}_{n}^{T} {λ}^{- 1} {n - 1}_{} {𝕩}_{n}} = \frac{{n - 1}_{} {𝕩}_{n}}{λ + {𝕩}_{n}^{T} {n - 1}_{} {𝕩}_{n}} .$$

When an error value between a predicted/estimated offset value and a correspondingly measured offset value is larger, the gain (i.e. the adaptive weighting) becomes larger, so that the flash memory controller 100 can more rapidly update and correct a next predicted/estimated offset value. Instead, when an error value between a predicted/estimated offset value and a correspondingly measured offset value is smaller, the gain (i.e. the adaptive weighting) becomes smaller, and the flash memory controller 100 can gradually update and correct the next predicted/estimated offset value so as to avoid data over-correction. [symbol] ₙ₋₁ [symbol] ₙ indicates the uncertainty level of the estimation/prediction. When [symbol] ₙ₋₁ [symbol] ₙ is larger, this indicates that the predicted/estimated result may have a larger difference, and [symbol] ₙ₋₁ [symbol] ₙ can also indicate the projection of the n-th error value eₙ onto the observation space, i.e. the n-th uncertainty level of the estimation/prediction onto the observation space. When [symbol] ₙ₋₁ [symbol] ₙ is larger, this also indicates that it is needed to make a larger correction for the values of coefficients (a,b). The value

$$λ + {𝕩}_{n}^{T} {n - 1}_{} {𝕩}_{n}$$

is used by the flash memory controller 100 to perform a normalization to make sure that the value of n-th gain

$${g}_{n} = \frac{{λ}^{- 1} {n - 1}_{} {𝕩}_{n}}{1 + {𝕩}_{n}^{T} {λ}^{- 1} {n - 1}_{} {𝕩}_{n}} = \frac{{n - 1}_{} {𝕩}_{n}}{λ + {𝕩}_{n}^{T} {n - 1}_{} {𝕩}_{n}}$$

can be within a reasonable range.

Then, the flash memory controller 100 updates the estimation uncertainty level to generate the (n−1)-th estimation uncertainty level

$${n}_{} = {λ}^{- 1} {n - 1}_{} - {g}_{n} ( {𝕩}_{n}^{T} ) ( {λ}^{- 1} {n - 1}_{} ) = \frac{( I - {g}_{n} {𝕩}_{n}^{T} ) {n - 1}_{}}{λ} .$$

When [symbol] ₙ is larger, this indicates that the estimation uncertainty level becomes higher for the predicted/estimated offset value. Instead, when [symbol] ₙ is smaller, this indicates that the estimation uncertainty level becomes lower for the predicted/estimated offset value.

$${g}_{n} {𝕩}_{n}^{T}$$

indicates a new measured information. When the measured error is smaller, the value

$${g}_{n} {𝕩}_{n}^{T}$$

becomes larger to make the (n−1)-th estimation uncertainty level [symbol] ₙ become smaller to increase the confidence level for the calculation of the next estimated/predicted offset value. If a larger change occurs, then the value [symbol] ₙ becomes larger. Finally, the flash memory controller 100 multiplies the n-th error value eₙ by the value of n-th gain gₙ to update and modify the coefficients (a,b) for the n-th calculation/iteration and updating based on the following equation:

$${[ \begin{matrix}a \\ b\end{matrix} ]}_{n}^{*} = {[ \begin{matrix}a \\ b\end{matrix} ]}_{n - 1}^{*} + {g}_{n} {e}_{n} .$$

By doing so, after updating the values of coefficients (a,b) for each iteration, the flash memory controller 100 can use the first linear equation of the first linear model to compute the data output (i.e. the predicted/estimated offset value yₙ′) based on the data input (i.e. the cell count xₙ) so as to compensate the default voltage of a specific read reference voltage to obtain the actual optimal voltage of the specific read reference voltage.

In one embodiment, the first linear model can be implemented by using a first lookup table to store the relation between the values of predicted/estimated offset value yₙ′ and the values of the cell count xₙ, and the flash memory controller 100 can input a value of the cell count xₙ to query the first lookup table to rapidly retrieve and directly obtain a corresponding value of the predicted/estimated offset value yₙ′ from the first lookup table. The first lookup table can be configured and stored by the external computer device 300 into the accelerator circuit 125 of the flash memory controller 100. Thus, by referencing the first lookup table of the first linear model, the accelerator circuit 125 can dynamically adjust the read reference voltage (s) to compensate for the variations of the threshold voltage distributions. The accelerator circuit 125 can input a specific input data (e.g. cell count) into the first lookup table to obtain a corresponding output data such as the voltage offset(s) which is/are used as the adjustment (s) to the read reference voltages used by the flash memory controller 100.

Additionally, in other embodiments, the build second linear model in FIG. 5 may execute based on a second linear equation:

$$y = c \times x + d ;$$

wherein y is the data output of the second linear equation and indicates the estimated/predicted offset value (i.e. a target offset value) of a specific read reference voltage to be moved from the default value into the actual optimal value when it is applied to read data, x is the data input of second linear equation and indicates the values of the measured data retention time of the flash memory device 101, and (c,d) are a pair of coefficients/parameters employed by the second linear equation. Similarly, the values of coefficients (c,d) can be calculated and configured by the external host device 300 such as a computer device in FIG. 3 before the flash memory device 101 leaves the factory or can be online (on-the-fly) updated by the CPU 105 (or accelerator circuit 125) of the flash memory controller 100 after leaving the factory. The operations of configuring and updating the values of coefficients (c,d) are similar to those of configuring and updating the values of coefficients (a,b), and are not detailed for brevity.

By doing so, after updating the values of coefficients (c,d) for each iteration, the flash memory controller 100 can use the second linear equation of the second linear model to compute the data output (i.e. the predicted/estimated offset value) based on the data input (i.e. the data retention time) so as to compensate the default voltage of a specific read reference voltage to obtain the actual optimal voltage of the specific read reference voltage.

Further, the second linear model can be also implemented by using a second lookup table to store the relation between the values of predicted/estimated offset value and the values of the data retention time, and the flash memory controller 100 can input a value of the data retention time to query the second lookup table to rapidly retrieve and directly obtain a corresponding value of the predicted/estimated offset value from the second lookup table. The second lookup table can be configured and stored by the external computer device 300 into the accelerator circuit 125 of the flash memory controller 100. Thus, by referencing the second lookup table of the second linear model, the accelerator circuit 125 can dynamically adjust the read reference voltage(s) to compensate for the variations of the threshold voltage distributions.

The above-mentioned first and second lookup tables can be stored in the accelerator circuit 125 of the flash memory controller 100. In an enterprise application such as enterprise SSD (solid-state drive) application, the flash memory controller 100 may perform different compensation operations in response to different usage conditions. For example, when performing a default read operation, the flash memory controller 100 can be used to perform a default read compensation operation which uses the information of first linear model (or second linear model) to predict the compensation value (s) for the read reference voltage(s) and transmit/store the compensation value(s) and relevant information about such default read operation back into the first linear model (or second linear model). In one embodiment, the accelerator circuit 125 uses the second linear model to output the predicted offset value in response to a corresponding value of the data retention time when the flash memory controller 100 performs a default read operation, without using the first linear model to improve the efficiency of data reading.

Further, when performing a read retry process, the flash memory controller 100 during the read retry process can be used to transmit the related information into the first linear model (or second linear model) for data training, and then can use the information of trained first linear model (or second linear model) to predict the compensation value (s) for the read reference voltage (s) for the next data read operation when the default read operation fails.

Further, when performing a background read scan operation, the flash memory controller 100 can be used to transmit the background read related information into the first linear model (or second linear model) for data training, and then can use the information of trained first linear model (or second linear model) to predict the compensation value (s) for the read reference voltage(s) for the next data read operation to make the read operations be more efficient. In one embodiment, the accelerator circuit 125 uses the first linear model to output the predicted offset value in response to a corresponding value of the cell count when the flash memory controller 100 performs a read retry operation or a background scan read operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flash memory controller, comprising:
an internal bus;
a first input/output interface, to be coupled between a host device and the internal bus;
a second input/output interface, to be coupled between a flash memory device and the internal bus;
a central processing unit, coupled to the internal bus, for managing flash memory operations; and
an accelerator circuit, coupled to the internal bus and arranged for generating an offset value of a specific read reference voltage to compensate a default value of the specific read reference voltage as an actual optimal value based on at least one characteristic model in response to at least one of a data retention time of the flash memory device and a cell count when the default value of the specific read reference voltage is applied.

2. The flash memory controller of claim 1, wherein the at least one characteristic model comprises a first linear model having a first linear equation:
$$y = a \times x + b ;$$
wherein y is a data output of the first linear equation and indicates a predicted offset value of the specific read reference voltage, x is a data input of the first linear equation and indicates the cell count corresponding to the default value of the specific read reference voltage, and (a,b) are a pair of coefficients employed by the first linear equation.

3. The flash memory controller of claim 2, wherein the accelerator circuit is arranged to perform an on-the-fly updating for the pair of coefficients (a,b) by performing following steps:
generating a predicted n-th offset value based on a n-th measured cell count and previous values of the pair of coefficients (a,b) when obtaining the n-th measured cell count and a corresponding n-th measured offset value for the specific read reference voltage;
calculating the n-th error value between the predicted n-th offset value and the corresponding n-th measured offset value;
updating a n-th adaptive gain by generating a projection of the n-th error value onto an observation space and normalizing the generated projection;
calculating and updating a n-th estimation uncertainty level by adding the n-th measured cell count multiplied by the n-th adaptive gain into a (n−1)-th estimation uncertainty level so as to indicate whether a system change occurs; and
using the previous values of coefficients (a,b), the n-th error value, and the n-th adaptive gain to compute and update next values of the pair of coefficients (a,b).

4. The flash memory controller of claim 2, wherein the first linear model is implemented using a first lookup table storing a relation between values of the predicted offset value and values of the cell count, and the accelerator circuit is arranged to use a specific value of the cell count to query the first lookup table to directly obtain a corresponding value of the predicted offset value based on the first linear model.

5. The flash memory controller of claim 1, wherein the at least one characteristic model further comprises a second linear model having a second linear equation:
$$y = c \times x + d ;$$
wherein y in the second linear equation indicates the predicted offset value of the specific read reference voltage, x in the second linear equation indicates the data retention time corresponding to the flash memory device, and (c,d) are a pair of coefficients employed by the second linear equation.

6. The flash memory controller of claim 5, wherein the second linear model is implemented using a second lookup table storing a relation between values of the predicted offset value and values of the data retention time, and the accelerator circuit is arranged to use a specific value of the data retention time to query the second lookup table to directly obtain a corresponding value of the predicted offset value based on the second linear model.

7. The flash memory controller of claim 5, wherein the accelerator circuit uses the second linear model to output the predicted offset value in response to a corresponding value of the data retention time when the flash memory controller performs a default read operation.

8. The flash memory controller of claim 5, wherein the accelerator circuit uses the first linear model to output the predicted offset value in response to a corresponding value of the cell count when the flash memory controller performs a read retry operation or a background scan read operation.

9. A compensation method of a flash memory controller, comprising:
providing a first input/output interface, to be coupled between a host device and an internal bus;
providing a second input/output interface, to be coupled between a flash memory device and the internal bus;
providing a central processing unit to manage flash memory operations; and
generating an offset value of a specific read reference voltage to compensate a default value of the specific read reference voltage as an actual optimal value based on at least one characteristic model in response to at least one of a data retention time of the flash memory device and a cell count when the default value of the specific read reference voltage is applied.

10. The compensation method of claim 9, wherein the at least one characteristic model comprises a first linear model having a first linear equation:
$$y = a \times x + b ;$$
wherein y is a data output of the first linear equation and indicates a predicted offset value of the specific read reference voltage, x is a data input of the first linear equation and indicates the cell count corresponding to the default value of the specific read reference voltage, and (a,b) are a pair of coefficients employed by the first linear equation.

11. The compensation method of claim 10, further comprising:
performing an on-the-fly updating for the pair of coefficients (a,b) by performing following steps:
generating a predicted n-th offset value based on a n-th measured cell count and previous values of the pair of coefficients (a,b) when obtaining the n-th measured cell count and a corresponding n-th measured offset value for the specific read reference voltage;
calculating the n-th error value between the predicted n-th offset value and the corresponding n-th measured offset value;
updating a n-th adaptive gain by generating a projection of the n-th error value onto an observation space and normalizing the generated projection;
calculating and updating a n-th estimation uncertainty level by adding the n-th measured cell count multiplied by the n-th adaptive gain into a (n−1)-th estimation uncertainty level so as to indicate whether a system change occurs; and
using the previous values of coefficients (a,b), the n-th error value, and the n-th adaptive gain to compute and update next values of the pair of coefficients (a,b).

12. The compensation method of claim 10, wherein the first linear model is implemented using a first lookup table storing a relation between values of the predicted offset value and values of the cell count, and the method further comprises:
using a specific value of the cell count to query the first lookup table to directly obtain a corresponding value of the predicted offset value based on the first linear model.

13. The compensation method of claim 9, wherein the at least one characteristic model further comprises a second linear model having a second linear equation:
$$y = c \times x + d ;$$
wherein y in the second linear equation indicates the predicted offset value of the specific read reference voltage, x in the second linear equation indicates the data retention time corresponding to the flash memory device, and (c,d) are a pair of coefficients employed by the second linear equation.

14. The compensation method of claim 13, wherein the second linear model is implemented using a second lookup table storing a relation between values of the predicted offset value and values of the data retention time, and the method further comprises:
using a specific value of the data retention time to query the second lookup table to directly obtain a corresponding value of the predicted offset value based on the second linear model.

15. The compensation method of claim 13, further comprising:
using the second linear model to output the predicted offset value in response to a corresponding value of the data retention time when the flash memory controller performs a default read operation.

16. The compensation method of claim 13, further comprising:
using the first linear model to output the predicted offset value in response to a corresponding value of the cell count when the flash memory controller performs a read retry operation or a background scan read operation.
